(19) United States
(12) Patent Application Publication
(10) Pub. No.: US 2021/0349315 A1
(43) Pub. Date: Nov. 11, 2021

(54) CAMERA CONTROLLER AND INTEGRATION FOR VR PHOTOGRAPHY/VIDEOGRAPHY

(71) Applicant: Sony Interactive Entertainment LLC, San Mateo, CA (US)

(72) Inventor: Elliot Brodzki, San Mateo, CA (US)

(21) Appl. No.: 16/871,697

(22) Filed: May 11, 2020

(51) Int. Cl. G02B 27/01

(52) U.S. Cl. CPC G02B 27/0172; G02B 2027/0138

(57) ABSTRACT

A camera shell may include only the controls and lenses of a camera without an imager and can be manipulated by a user wearing a virtual reality head-mounted display (HMD). The camera shell is imaged, and an image of the shell is presented on the HMD along with a virtual camera view port. The user can manipulate the controls and the shell sends signals in respond to the HMD, which presents a virtual image in the view port as would have been taken with a real camera.

### FIELD

The application relates generally to Camera Controllers Integration for VR Photography/Videography.

### BACKGROUND

As understood herein, photographers may wish to hone their skills with a particular camera using a realistic emulation system that does not require trial and error with an actual (and potentially expensive) camera, using an emulation system that the photographer may already possess for other purposes.

### SUMMARY

Accordingly, present principles provide an assembly that includes at least one camera peripheral (CP) comprising at least a first control. The assembly also includes at least one head-mounted display (HMD) configured to present at least a view port on the HMD. The view port includes a virtual image that is established responsive to manipulation of the first control on the CP and to an orientation of the CP to emulate an image from the CP.

In an example embodiment, the CP can include at least one wireless transceiver configured to send a signal to the HMD indicating the manipulation of the first control. In some implementations the CP includes a housing supporting the first control and having no imager therein. In other implementations the CP includes a housing supporting the first control and having an imager therein.

The HMD and/or a computer simulation console and/or a computer simulation controller may be configured to identify the manipulation of the first control and the orientation of the CP using computer vision executed on the CP. Without limitation, the first control may be correlated to a shutter button, a shutter speed control, or other control. The HMD can be configured to present on the display a virtual image of the CP in virtual space based at least in part on the orientation.

In another aspect, a method includes identifying an orientation of a camera peripheral (CP), and at least in part based on the orientation, presenting a head-mounted display (HMD) a virtual representation of a view port of the CP.

In another aspect, a system includes at least one camera peripheral (CP) with at least a first control and configured to wirelessly send information representing manipulation of the first control. At least one sensor is configured to sense an orientation of the CP in physical space. The system further includes at least one head-mounted display (HMD) configured to present an image in a virtual view port according to the information representing manipulation of the first control and the orientation of the CP in physical space sensed by the sensor.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 illustrates an example assembly consistent with present principles;

FIG. 2 illustrates an example non-limiting camera peripheral;

FIG. 3 illustrates another example non-limiting camera peripheral;

FIG. 4 illustrates a specific example system;

FIG. 5 illustrates a presentation on a head-mounted display (HMD);

FIG. 6 illustrates example logic in flow chart format consistent with present principles.

FIG. 7 illustrates example alternate logic in flow chart format consistent with present principles.

### DETAILED DESCRIPTION

This disclosure relates generally to computer ecosystems including aspects of consumer electronics (CE) device networks such as but not limited to computer simulation networks such as computer game networks as well as standalone computer simulation systems. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

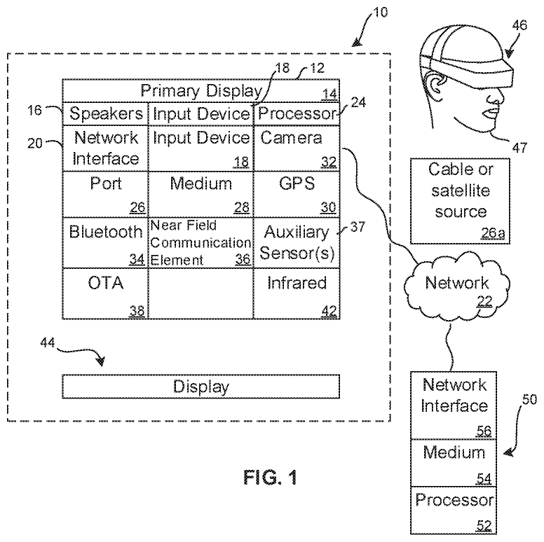

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input ports 26 such as a high definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or, the source 26a may be a game console or disk player containing content. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimensions.

Continuing the description of the AVD 12, in some embodiments the AVD 12 may include one or more cameras 32 that may be a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12.

Still referring to FIG. 1, in addition to the AVD 12, the system 10 may include one or more other CE device types. In one example, a first CE device 44 may be used to send computer game audio and video to the AVD 12 via commands sent directly to the AVD 12 and/or through the below-described server while a second CE device 46 may include similar components as the first CE device 44. In the example shown, the second CE device 46 may be configured as a computer game controller manipulated by a player or an HMD worn by a player 47. In the example shown, only two CE devices 44, 46 are shown, it being understood that fewer or greater devices may be used. A CE device herein may implement some or all of the components shown for the AVD 12. Any of the components shown in the following figures may incorporate some or all of the components shown in the case of the AVD 12.

Now in reference to the afore-mentioned at least one server 50, it includes at least one server processor 52, at least one tangible computer readable storage medium 54 such as disk-based or solid state storage, and at least one network interface 56 that, under control of the server processor 52, allows for communication with the other devices of FIG. 1 over the network 22, and indeed may facilitate communication between servers and client devices in accordance with present principles. Note that the network interface 56 may be, e.g., a wired or wireless modem or router, Wi-Fi transceiver, or other appropriate interface such as, e.g., a wireless telephony transceiver.

Accordingly, in some embodiments the server 50 may be an Internet server or an entire server “farm”, and may include and perform “cloud” functions such that the devices of the system 10 may access a “cloud” environment via the server 50 in example embodiments for, e.g., network gaming applications. Or, the server 50 may be implemented by one or more game consoles or other computers in the same room as the other devices shown in FIG. 1 or nearby.

As set forth in detail herein, the housing design of a camera, such as but not limited to a Sony Alpha line camera that photographers are already familiar with, can be used as a tool to be a controller into virtual reality (VR). With application programming interface (API) integration into computer simulation software/games, professional level photography controls are enabled in a one-to-one fashion for taking digital photos/videos while within a fully virtual world.

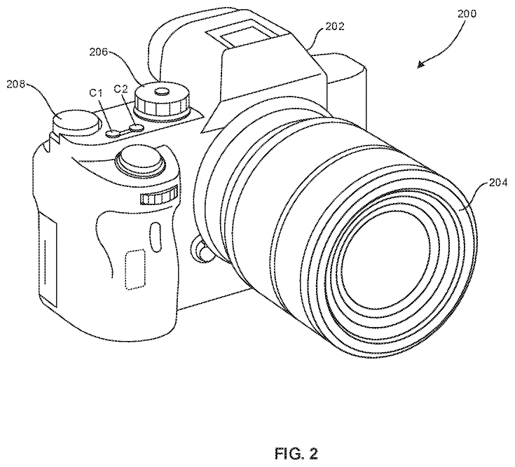

FIG. 2 illustrates such a device 200, referred to herein as a “camera peripheral” or “CP”. As shown, the CP 200 may be in all essential respects identical in configuration and operation to a commercial embodiment of a camera it emulates, with the following exceptions. The CP 200 need not contain an imager such as a charge-coupled device (CCD) or complementary-metal-oxide semiconductor (CMOS) imager. However, the CP 200 may include sensors for detecting when controls on a housing 202 of the CP 200 are manipulated, for detecting a type of lens 204 engaged with the housing, and for detecting camera settings as established by a user, along with a wireless transceiver to send signals to, for example, the HMD 46 shown in FIG. 1 for purposes described herein.

It is to be understood that in other embodiments, the CP 200 may be an actual commercial embodiment of a functioning digital camera, as described in alternate disclosure below.

In the non-limiting example shown in FIG. 2, the CP 200 emulates a Sony Alpha RII camera with plural controls that can be manipulated by a person. Among these controls are a C1 function button and a C2 function button to establish various functions. Also, a rotatable camera mode dial 206 may be provided to establish a camera mode such as program mode, aperture priority mode, shutter priority mode, manual mode, or an auto or scene mode. A rotatable exposure compensation dial 208 also may be provided to manually adjust exposure.

Although not shown in FIG. 2, on the back of the housing 202 may be a C4 button, left, right, down controls, auto exposure lock (AEL), auto focus/manual focus (AF/MF) selection, and a center click wheel button. These controls, such as the click wheel, may be used to establish, among other settings, aperture, shutter speed, ISO (a control to brighten or darken a photo). The controls also may be manipulable to establish white balance, creative style, picture effect, etc.

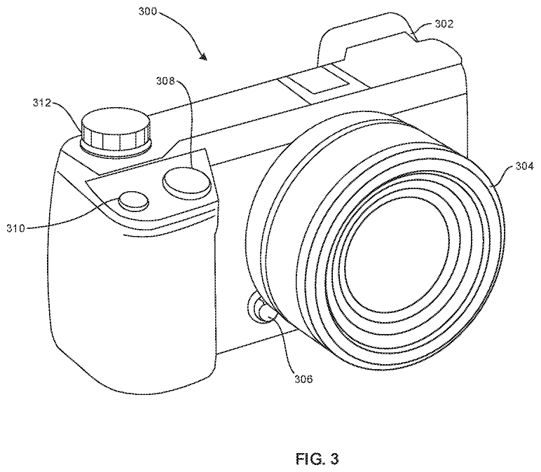

FIG. 3 shows another non-limiting example CP 300 with a housing 302, lens 304, and plural manipulable controls. The example controls may include, e.g., a lens release button 306, a power switch 308, a function button 310, and a control dial 312.

It is to be understood that while FIGS. 2 and 3 illustrate example CPs, a CP may take other form factors and have other controls than those shown.

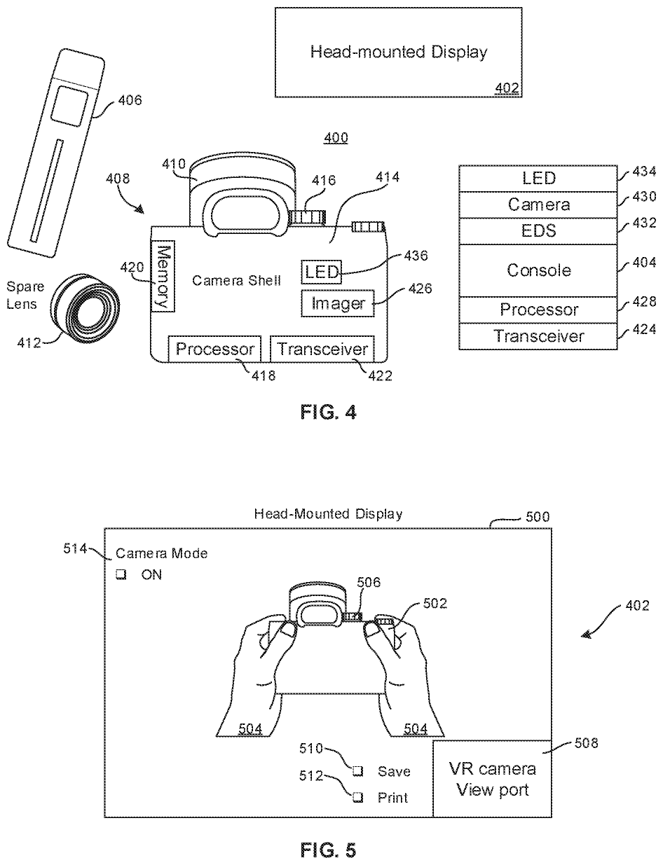

Turning now to FIG. 4, a system 400 may include a VR HMD 402 presenting images demanded by a computer simulation console 404 such as but not limited to a Sony PlayStation. A computer simulation executed by the console 404 may be controlled by a player manipulating a simulation controller 406.

A CP 408 may be provided as already discussed. In the example shown, the CP 408 includes a lens 410, one or more spare lenses 412, and a camera housing 414 supporting the lens 410 and one or more controls 416. FIG. 4 schematically illustrates that the CP 408 may include one or more processors 418 accessing executable instructions on one or more computer storage media 420 to receive signals from the controls 416 indicating manipulation thereof and to transmit, via one or more wireless transceivers 422, information pertaining to control manipulation to, e.g., a wireless transceiver 424 on the console 404 to execute logic herein. The CP 408 may or may not include an imager 426.

In turn, signals received from the CP 408 at the console 404 may be processed by one or more processors 428 of the console 408 that can access instructions on one or more computer storage media to send demanded images to the HMD 402. The console processor 428 may receive information from one or more sensors including, for example, a camera 430 and an event-driven sensor (EDS) 432 for purposes to be shortly disclosed. The processor 428 may activate one or more lamps 434 such as a light emitting diode (LED). One or more LEDs 436 may be provided on the CP 408.

With the above in mind, it may be appreciated that the CP 408 may be tracked by the system 400 using, for example, the camera 430 on the console 404 or other components of the system 400. The LED(s) 436 on the CP 408 may aid in tracking. Essentially, the CP 408 is tracked using computer vision based on, for instance, image recognition.

As shown in FIG. 5, on a display 500 of the HMD 402, an image 502 of the CP 408 is rendered on a one-to-one basis along with images 504 of the user's digitally represented hands. Images 506 of controls such as buttons, nobs, switches, zooming lenses, etc. (the controls on the camera) and the images 504 of the user's hands are animated to move and react exactly in VR as they do in the real world in real time. The changes made via these controls are reflected in the VR representation 502 of the CP 408 itself.

FIG. 5 also shows that a view port 508 may be presented on the HMD 402. The view port 508 is generated using computer simulation rendering techniques to emulate the physical changes made to the CP 408 in the real world, including its orientation and control manipulation, to present an image in the view port as its real world equivalent camera would render.

It may now be appreciated that the user can manipulate the CP 408 to generate photos within a computer simulation depressing the proper button on the physical CP 408, and the resulting photo can then be saved to the long-term storage of the device. To this end, a save selector 510 may be presented on the HMD or other display to enable a user to save the photo. The photo can be displayed within VR in the view port 508 as shown and may be physically printed out to a printer in the system 400. To this end, a print selector 512 may be presented on the HMD or other display to enable a user to print the photo. Also, a camera mode on/off selector 514 may be presented on the HMD or other display to enable a user to enable and disable the camera feature presented herein. The VR representation of an actual photo stored in memory may be modified physically with the other VR controllers used for general VR interactions to allow for manual manipulation of size, color, grading, (e.g., to stretch a photo to view it as a wall sized print).

In the case of video recording, the CP 408 may be put into its video recording mode. The CP 408 may be provided with a separate button from the photo shutter button for this purpose. The virtual video can be recorded out to the long-term storage as it is being recorded with the VR controller and stopped once storage limitations require it. Or, the recording may be stopped by another physical button press on the CP 408. Reviewing the video footage after it has been recorded may be done in the same manner as the photography printout. Instead of a still image, a video player is “printed out” and may be resized and position in the VR space for the user to watch while still in VR.

In example, the lenses 410, 412 in FIG. 4 may be “fake” lenses with all the requisite controls for manual adjustments that are tied into adjusting the lens. These adjustments are represented in VR as well in the final output of photos and video taken within the VR scene. There could be multiple detachable lenses for this device in the various lengths, sizes, and weights to mimic the range of professional lenses that are available today for, as but one example, Sony Alpha interchangeable lens cameras.

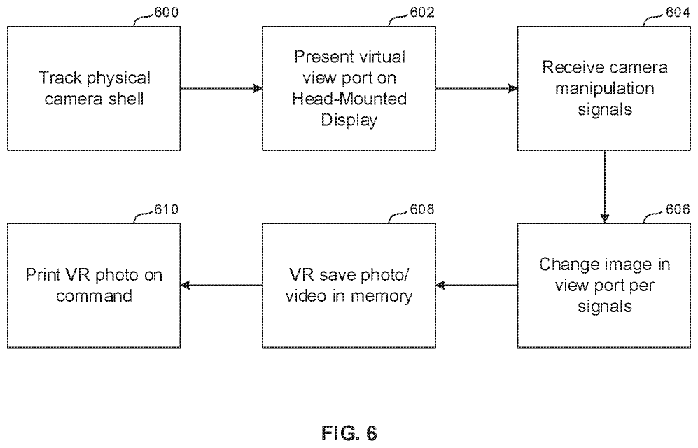

FIG. 6 illustrates logic consistent with the disclosure herein. Commencing at block 600, the cameral peripheral is tracked using any of the appropriate sensors herein, such as one or more cameras. Both the location in space and orientation of the camera are tracked so that the camera field of view may be determined emanating from the location of the lens of the camera.

Proceeding to block 602, the virtual view port of the camera is presented on the HMD, showing the view the camera would have in the virtual world based on its location and orientation in physical space. Moving to block 604, signals from the camera peripheral may be received indicating manipulation of one or more camera controls, and then at block 606 the image in the VR view port is changed according to the signals. For example, brightness of the image may be changed, blur may be added or subtracted from the image, and so on based on the settings of the camera peripheral as established by the used. As the real-world camera peripheral moves and changes implemented using its controls, the image in the VR view port changes accordingly.

Block 608 indicates that the VR image in the view port may be saved according to disclosure herein as a virtual “photograph” and if desired printed on hard copy physical paper at block 610.

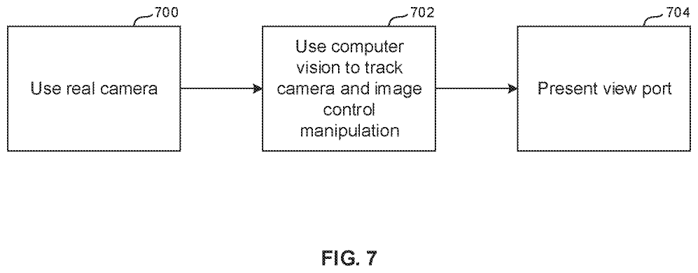

FIG. 6 assumes a custom camera peripheral that does not necessarily have an imager and that is configured to send signals to the console or HMD according to manipulation of its controls. FIG. 7 illustrates logic that may be used in the case of a commercial camera being used as the camera peripheral. Commencing at block 700, a real camera is used by the user and at block 702 machine vision is used to determine the location and orientation of the camera in the real world as well as to detect the user manipulating the controls of the real camera. In some embodiments the CP processor may execute an application to cause signals representing manipulation of the controls and their settings to the simulation console and/or HMD as is done in FIG. 6 so that machine vision need be used only for orientation and position of the camera peripheral. Proceeding to block 704, based on the machine vision sensing at block 702 the virtual view port is presented on the HMD.

In rendering the image in the view port 508 based on camera position/orientation and control settings, various computer simulation rendering techniques may be used. For example, ray cast or ray tracing over time may be used to emulate a blur to account for emulated motion of a virtual object during the period the camera shutter is emulated to be open. Per pixel shading may be used to merge images to model blur. The global illumination modeled in the simulation may be used to brighten/darken the virtual image in the view port. A library of software shaders may be accessed to emulate the effects of different lenses, including a screen space shader, a per pixel shader, etc. which may be applied to the texture of VR objects in the emulated photograph. To this end, a graphics library may be generated to correlate camera button manipulation effects to sliders.

It will be appreciated that whilst present principals have been described with reference to some example embodiments, these are not intended to be limiting, and that various alternative arrangements may be used to implement the subject matter claimed herein.

What is claimed is:

1. An assembly comprising:
at least one camera peripheral (CP) comprising at least a first control; and
at least one head-mounted display (HMD) configured to present at least a view port on the HMD, the view port comprising a virtual image that is at least in part established responsive to manipulation of the first control on the CP and to an orientation of the CP to emulate an image from the CP.

2. The assembly of claim 1, wherein the CP comprises at least one wireless transceiver configured to send a signal to the HMD indicating the manipulation of the first control.

3. The assembly of claim 1, wherein the CP comprises a housing supporting the first control and having no imager therein.

4. The assembly of claim 1, wherein the CP comprises a housing supporting the first control and having an imager therein.

5. The assembly of claim 1, wherein the HMD and/or a computer simulation console and/or a computer simulation controller is configured to identify the manipulation of the first control and the orientation of the CP using computer vision executed on the CP.

6. The assembly of claim 1, wherein the first control is correlated to a shutter button.

7. The assembly of claim 1, wherein the first control is correlated to a shutter speed control.

8. The assembly of claim 1, wherein the HMD is configured to present on the display a virtual image of the CP in virtual space based at least in part on the orientation.

9. A method, comprising:
identifying an orientation of a camera peripheral (CP); and
at least in part based on the orientation, presenting a head-mounted display (HMD) a virtual representation of a view port of the CP.

10. The method of claim 9, wherein the CP contains no imager.

11. The method of claim 9, wherein the CP contains an imager.

12. A system comprising:
at least one camera peripheral (CP) comprising at least a first control and configured to wirelessly send information representing manipulation of the first control;
at least one sensor configured to sense an orientation of the CP in physical space; and
at least one head-mounted display (HMD) configured to present an image in a virtual view port according to the information representing manipulation of the first control and the orientation of the CP in physical space sensed by the sensor.

13. The system of claim 12, wherein the sensor is configured to sense a location of the CP in physical space, and the HMD is configured to present the image in the virtual view port according to the location of the CP in physical space sensed by the sensor.

14. The system of claim 12, wherein the sensor is supported by a computer simulation controller configured to send simulation control signals to a computer simulation console.

15. The system of claim 12, wherein the sensor is supported by the HMD.

16. The system of claim 12, wherein the sensor is supported by a computer simulation console configured to send simulation image signals to the HMD.

17. The system of claim 12, wherein the CP does not include an imager.

18. The system of claim 12, wherein the CP comprises at least one imager.

19. The system of claim 12, wherein the CP comprises at least one wireless transceiver configured to send a signal to the HMD indicating the manipulation of the first control.

20. The system of claim 12, wherein the first control is correlated to a shutter button.
